(19) United States
(12) Patent Application Publication
(10) Pub. No.: US 2017/0255453 A1
(43) Pub. Date: Sep. 7, 2017

(54) INFORMATION PROCESSING DEVICE AND METHOD OF DISPLAYING PROGRAM EXECUTION STATE

(71) Applicant: FUJITSU LIMITED, Kawasaki-shi (JP)

(72) Inventor: Motoyuki Kawaba, Kawasaki (JP)

(73) Assignee: FUJITSU LIMITED, Kawasaki-shi (JP)

(21) Appl. No.: 15/418,894

(22) Filed: Jan. 30, 2017

(30) Foreign Application Priority Data
Mar. 7, 2016 (JP) 2016-043899

(51) Int. Cl. G06F 9/45

(52) U.S. Cl. CPC G06F 8/443

(57) ABSTRACT

An information processing device includes a memory and a processor coupled to the memory. The processor is configured to receive a designation of a first function within a first program. The processor is configured to: extract, from among third functions called in first function calls during execution of the first program, a second function with a call depth same as a call depth of the first function on basis of execution information. The call depth of a specific function is a number of functions traced along a sequence of second function calls from a start function to the specific function. The execution information indicates call depths of the respective third functions. The start function is a function with which the execution of the first program starts. The processor is configured to: output information of the second function.

### CROSS-REFERENCE TO RELATED APPLICATION

This application is based upon and claims the benefit of priority of the prior Japanese Patent Application No. 2016-043899, filed on Mar. 7, 2016, the entire contents of which are incorporated herein by reference.

### FIELD

The embodiment discussed herein is related to an information processing device and a method of displaying a program execution state.

### BACKGROUND

Conventionally, for example, a sampling method or a function call history recording method is known as a method of collecting profile information used for identifying a bottleneck point in an application program. In the sampling method, an interrupt is made to a program, a program counter at the time when the interrupt is made is recorded, and a calling relationship between functions is recorded using information of a function caller on a stack and a stack in the caller. The function call history recording method is a method of embedding, during compilation, a code used for information collection. For example, a profile option is designated during compilation and a particular object is generated.

As a related art, for example, there is a method in which interrupts are generated during execution of an application program, call information is acquired which indicates a path from a main function to a function that is executed at the time when the respective interrupts are generated. Pieces of the acquired call information are aggregated and displayed on a cathode ray tube (CRT) monitor when the execution of the application program is ended.

Related techniques are disclosed in, for example, Japanese Laid-Open Patent Publication No. 2000-250780.

In the related art, however, it is difficult to perform an analysis on the detailed breakdowns of an execution time in a unit of a processing phase composed of several processes that implement a certain function and an analysis for identifying a bottleneck point in an application may become difficult. For example, in the sampling method, only a function which is currently being executed and a caller function may be identified and it is difficult to perform an estimation of a processing time for each processing phase. Furthermore, the object code may be changed in the function call history recording method.

### SUMMARY

According to an aspect of the present invention, provided is an information processing device including a memory and a processor coupled to the memory. The processor is configured to receive a designation of a first function within a first program. The processor is configured to: extract, from among third functions called in first function calls during execution of the first program, a second function with a call depth same as a call depth of the first function on basis of execution information. The call depth of a specific function is a number of functions traced along a sequence of second function calls from a start function to the specific function. The execution information indicates call depths of the respective third functions. The start function is a function with which the execution of the first program starts. The processor is configured to: output information of the second function.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a method of displaying a program execution state according to an embodiment;

FIG. 2 is a diagram illustrating an exemplary hardware configuration of an information processing device according to an embodiment;

FIG. 3 is a diagram illustrating an exemplary data structure of a profile information DB according to an embodiment;

FIG. 4 is a diagram illustrating an exemplary functional configuration of an information processing device according to an embodiment;

FIG. 5 is a diagram illustrating an example of stored contents of a stack area during execution of a program;

FIG. 6 is a diagram illustrating an example of stored contents of a profile information DB according to an embodiment;

FIG. 7 is a diagram illustrating a specific example of execution state information according to an embodiment;

FIG. 8 is a flowchart illustrating an exemplary processing of generating profile information performed by an information processing device according to an embodiment;

FIG. 9 is a flowchart illustrating exemplary processing in a COUNT process according to an embodiment;

FIG. 10 is a flowchart illustrating exemplary processing in a COUNT process according to an embodiment; and

FIG. 11 is a flowchart illustrating exemplary processing of displaying a program execution state according to an embodiment.

### DESCRIPTION OF EMBODIMENT

In the following, an embodiment of an information processing device and a method of displaying a program execution state according to the present disclosure will be described in detail with reference to the accompanying drawings.

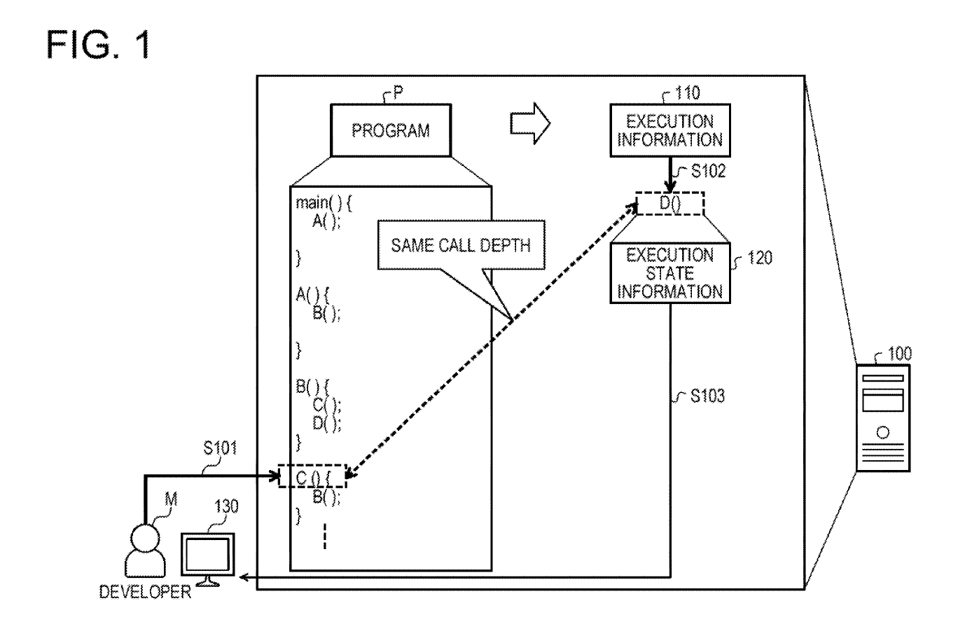

FIG. 1 is a diagram illustrating a method of displaying a program execution state according to an embodiment. In FIG. 1, an information processing device 100 is a computer supporting an analysis of a program P. The program P is a computer program, such as an application program, to be analyzed. The information processing device 100 may be, for example, a server or a general purpose arithmetic device such as a personal computer (PC) used by a developer M of the program P.

In order to identify a bottleneck point of the program P, it is effective to grasp an execution time of respective processing phases. A processing phase is composed of several processes that implement a certain function. For example, the execution time of the respective processing phases may be compared to each other and thus it becomes possible to grasp how the processing phases are distributed within the program P and easily identify the bottleneck point.

However, when it is intended to grasp all processing phases within the program P with a manual operation, it is needed to cover the entire program P while referencing a technical description or the like, and thus time and efforts are needed. In a database, for example, there are processing phases of parsing, planning, and execution. There may be processing phases such as an optimization phase and a dynamic compilation phase depending on a type of the database, and it is difficult to prepare a list of the processing phases without having inside knowledge of a program.

On the other hand, a function name corresponding to any one of the processing phases within the program P may be often recognized. In addition, functions with the same call depth may be often the functions which are respectively responsible for a processing phase. The call depth of a specific function is the number of functions traced along a sequence of function calls from a function (e.g., a main function) serving as an execution starting point (an entry point) of the program P to the specific function. That is, another function with the same call depth as that of a function which is responsible for a certain processing phase has a high possibility of being responsible for a different processing phase.

In the present embodiment, a method of displaying a program execution state will be described in which another function with the same call depth as that of a function designated by a user (e.g., a developer M) is extracted based on execution information obtained by executing the program P and information of the extracted other function is output. In the following, an example of a process performed by the information processing device 100 will be described.

(S101) The information processing device 100 receives a designation of a first function within the program P. The function is an instruction group that receives data that is called an “argument”, executes a predetermined process, and outputs a result. The function is one of constitutional elements of the program P and includes, for example, a subroutine and a method.

In the example of FIG. 1, an example of a source code of the program P is illustrated. In the drawing, a portion of the source code is extracted to be represented. The first function is designated by designating, for example, a function name. Here, it is assumed that C( ) responsible for a certain processing phase of the program P is designated as a first function by a developer M.

(S102) The information processing device 100 extracts another function with the same call depth as that of the designated first function on the basis of execution information 110. The execution information 110 is information that indicates, with respect to respective functions called during execution of the program P, a call depth from a function serving as an execution starting point (entry point) of the program P. The execution information 110 is generated during, for example, the execution of the program P.

In the example of FIG. 1, the function serving as an execution starting point of the program P is main( ). The call depth of C( ) designated as the first function is “4”. Therefore, the information processing device 100 extracts another function with the same call depth of “4” as that of C( ) which is the first function, on the basis of the execution information 110. Here, D( ) within the program P is extracted as another function.

(S103) The information processing device 100 outputs information of the extracted other function. Here, the information of the extracted other function is information capable of identifying a function with the same call depth as that of the first function and includes, for example, a function name of the extracted other function. In the example of FIG. 1, the information processing device 100 displays, for example, execution state information 120 including a function name “D” of D( ) extracted as another function on the display 130.

The display 130 may be provided in the information processing device 100 or provided in another device coupled to the information processing device 100.

As such, according to the information processing device 100, another function called in the same call depth as that of the first function may be extracted in response to a reception of the designation of first function within the program P and information of the extracted other function may be output. With this, it is possible to provide information of another function having a high possibility of being executed with the first function in a pair.

In the example of FIG. 1, the developer M may grasp D( ) having a high possibility of being executed in a pair with C( ) designated as the first function. In other words, it is possible to grasp not only the processing phase for which C( ) is responsible but also another processing phase for which D( ) is responsible. With this, the detailed breakdowns may be calculated for each of the processing phases for which respective functions of C( ) and D( ) are responsible and, for example, it becomes possible to determine the processing distribution of the processing phases within the program P thereby enabling to support identification of the bottleneck point.

Next, descriptions will be made on an exemplary hardware configuration of the information processing device 100.

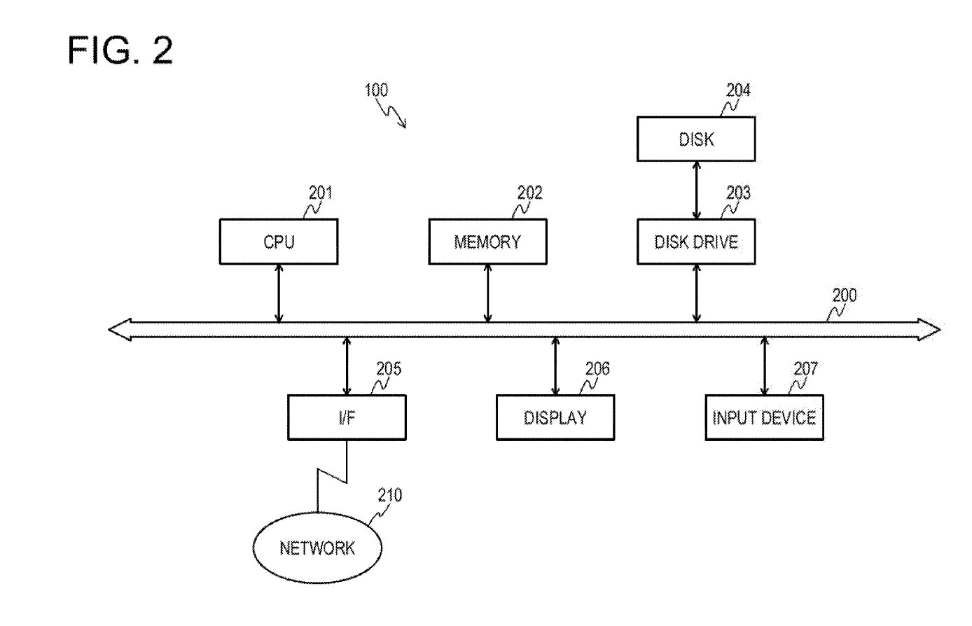

FIG. 2 is a diagram illustrating an exemplary hardware configuration of the information processing device 100. In FIG. 2, the information processing device 100 includes a central processing unit (CPU) 201, a memory 202, a disk drive 203, a disk 204, an interface (I/F) 205, a display 206, and an input device 207. Respective configuration units are coupled to each other through a bus 200.

The CPU 201 is responsible for the control of the entire information processing device 100. The memory 202 includes, for example, a read-only memory (ROM), a random access memory (RAM), and a flash ROM. Specifically, for example, the flash ROM or the ROM stores therein various programs and the RAM is used as a work area of the CPU 201. The program stored in the memory 202 is loaded onto the CPU 201 so as to cause the CPU 201 to execute a coded process.

The disk drive 203 controls data read/write for the disk 204 in accordance with the control of the CPU 201. The disk 204 stores therein data recorded under the control of the disk drive 203. The disk 204 may include, for example, a magnetic disk and an optical disk.

The I/F 205 is coupled to a network 210 such as, for example, a local area network (LAN), a wide area network (WAN), and the Internet through a communication line, and coupled to other devices through the network 210. The I/F 205 is responsible for interfacing between internal units of the information processing device 100 and the network 210, and controls an input/output of data from other devices.

The display 206 displays data such as a document, an image, and function information, as well as a cursor, an icon, or a tool box. For example, a liquid crystal display, a CRT, or the like may be adopted as the display 206. A display 130 illustrated in FIG. 1 corresponds to, for example, the display 206.

The input device 207 is provided with keys for inputting, for example, characters, numerals, and various instructions, to input data. The input device 207 may be a keyboard, a mouse, a touch panel type input pad, or a numeric keypad.

The information processing device 100 may also include, for example, a solid state drive (SSD) or a printer, in addition to the configuration units described above. The information processing device 100 may not include, for example, the display 206 or the input device 207.

Next, descriptions will be made on an exemplary data structure of the profile information database (DB) 300 provided in the information processing device 100. The profile information DB 300 is implemented with a storage device such as, for example, the memory 202 or the disk 204 illustrated in FIG. 2.

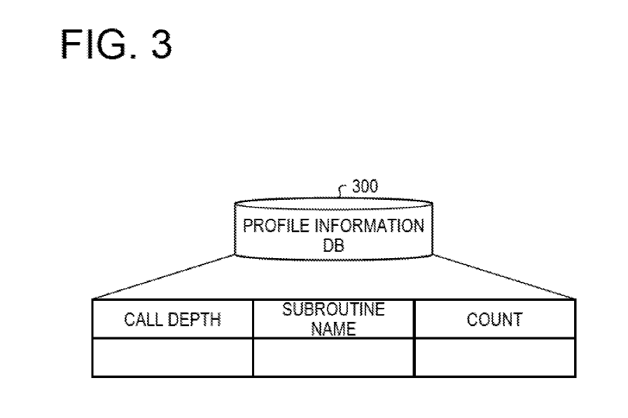

FIG. 3 is a diagram illustrating an exemplary data structure of the profile information DB 300. In FIG. 3, the profile information DB 300 includes fields for a call depth, a subroutine name, and a count, and sets information in each field so as to store profile information as a record.

The call depth is a depth of function calls within the program P and indicates a call depth from the function serving as the execution starting point (an entry point) of the program P. The call depth has the smallest value for a function located at the nearest side to the caller, that is, the function serving as the execution starting point of the program P, and the value gradually increases from that function toward a call destination side.

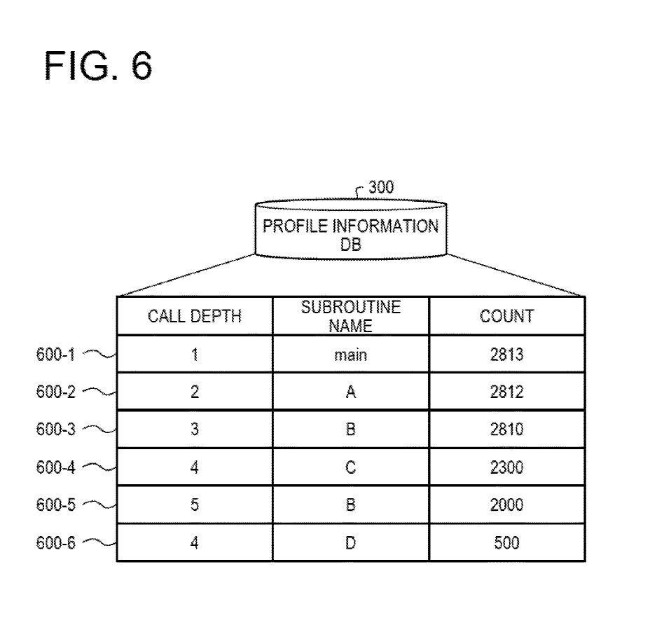

The subroutine name corresponds to a function name of a function within the program P. The count is an index value indicating a length of the processing time of the respective functions within the program P, in respective call depths. The count is “0” in an initial state. A specific example of the profile information will be described later with reference to FIG. 6.

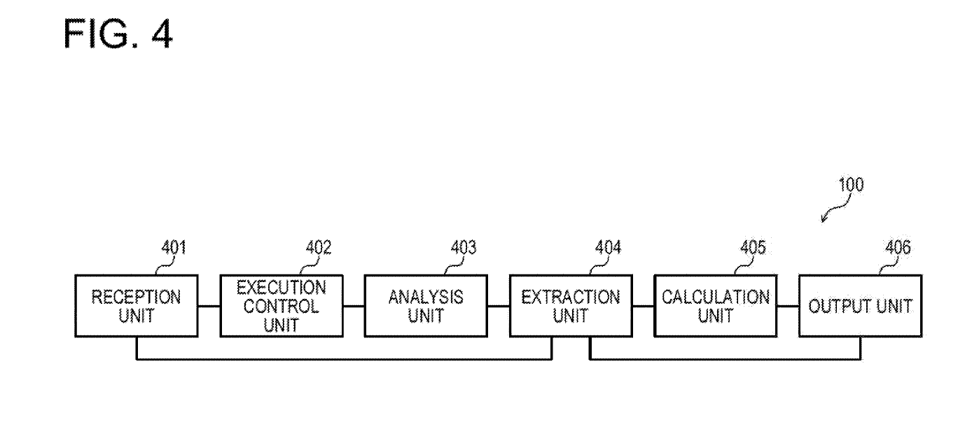

FIG. 4 is a diagram illustrating an exemplary functional configuration of the information processing device 100. As illustrated in FIG. 4, the information processing device 100 includes a reception unit 401, an execution control unit 402, an analysis unit 403, an extraction unit 404, a calculation unit 405, and an output unit 406. The units of the reception unit 401 to the output unit 406 are functional units serving as a control unit. Specifically, for example, functions of the units are implemented by causing the CPU 201 to execute a program stored in the storage device such as the memory 202, the disk 204, or the like illustrated in FIG. 2 or the I/F 205. Processing results of the respective functional units are stored in the storage device such as, for example, the memory 202, the disk 204, or the like.

The reception unit 401 receives an input of a program P (source code) to be analyzed. Specifically, for example, the reception unit 401 receives input of the program P through, an input operation by a user using the input device 207 illustrated in FIG. 2. The reception unit 401 may receive input of the program P by receiving the program P from other devices through the network 210.

The execution control unit 402 controls execution of the program P. Specifically, for example, the execution control unit 402 starts the execution of the program P in response to a reception of an execution start instruction for the program P. The execution start instruction for the program P is input by, for example, an input operation by a user using the input device 207.

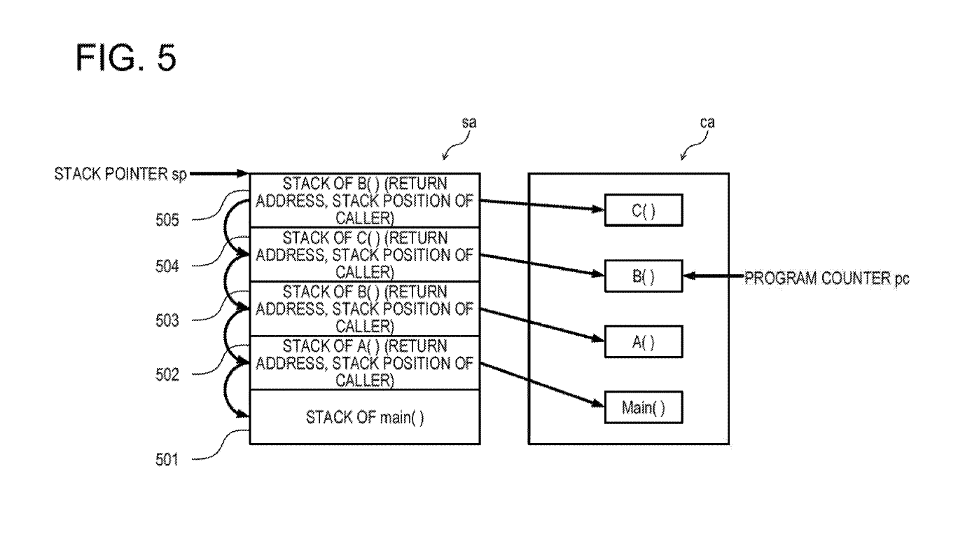

The analysis unit 403 generates profile information of the program P on the basis of information of a program counter pc (FIG. 5) and information of a stack area sa (FIG. 5) during execution of the program P. The profile information indicates an execution state of the program P and corresponds to, for example, the execution information 110 illustrated in FIG. 1.

The program counter pc is a register that stores therein a memory address (e.g., an address within the memory 202 illustrated in FIG. 2) of the instruction to be executed next. The stack area sa is a memory area in the memory and has a data structure (LIFO: Last In First Out) in which the most recently added data is taken off first. In the stack area sa, a stack frame generated each time when a function within the program P is called is stored. When the called function returns, a stack frame generated at the time when the function is called is deleted.

In the stack frame, for example, a return address (e.g., a point where a call occurs), an argument provided to the function (e.g., an argument for a function calling), a local variable of the function (e.g., a local variable declared inside the called function), and the like are included. Accordingly, even when functions are called one after another, the stack frames within the stack area sa may be referenced so as to make it possible for the called function to return to the caller in order.

Specifically, for example, the analysis unit 403 generates profile information of the program P or updates the generated profile information at a predetermined timing during execution of the program P. The predetermined timing may be, for example, a timing at a predetermined time interval or a timing at which a function is newly called.

The timing at the predetermined time interval may be specified by, for example, generating a signal at the predetermined time interval. The timing of a function call may be specified, for example, by making an interrupt in response to a function call.

Description will be made on a specific process performed by the analysis unit 403 with reference to FIG. 5. Here, it is assumed that the respective functions of main( ) [symbol] A( ) [symbol] B( ) [symbol] ( ) [symbol] B( ) are called in this [symbol] order during execution of the program P illustrated in FIG. 1. In the following description, a function within the program P may be referred to as a “subroutine”.

FIG. 5 is a diagram illustrating an example of stored contents of the stack area sa during execution of the program P. In FIG. 5, the stack area sa and a code area ca within the memory 202 are illustrated. In the stack area sa, stack frames 501 to 505 are stored. The code area ca is a memory area for storing instructions within the memory 202.

First, the analysis unit 403 references a value of the program counter pc to identify a subroutine name of a current subroutine. Specifically, for example, the analysis unit 403 calculates a memory address of the current subroutine, that is, a memory address of an instruction preceding the instruction to be executed next, from the value of the program counter pc. The analysis unit 403 references, for example, a symbol table to identify a subroutine name of the current subroutine corresponding to the calculated memory address.

In the example of FIG. 5, it is assumed that a subroutine name “B” of a subroutine B( ) is identified from the value of the program counter pc as the subroutine name of the current subroutine.

The analysis unit 403 references a value of a stack pointer sp to identify a current stack position. The stack pointer sp is a register holding a top address of the stack area sa, that is, an address of a location most recently referenced within the stack area sa. When new data is stored in the stack area sa, the value of the stack pointer sp is increased by an amount of the data and when data is taken off from the stack area sa, the value of the stack pointer sp is decreased by an amount of the data.

In the example of FIG. 5, a stack position at which the stack frame 505 is stored is identified as the current stack position from the value of the stack pointer sp.

Next, the analysis unit 403 sequentially traces the stack frames starting from the current stack position so as to identify a subroutine called in each call depth from the current subroutine to the subroutine serving as the execution starting point. In the example of FIG. 5, the following subroutines of the respective call depths are identified (call depth: subroutine name).

1: main, 2: A, 3: B, 4: C, and 5: B

The analysis unit 403 correlates, for example, respective subroutine names of identified subroutines with the call depths having an initial value of “0” to be registered in a profile information DB 300 illustrated in FIG. 3. The analysis unit 403 counts up a count corresponding to a pair of the registered subroutine name and call depth by one. When the pair of the subroutine name and the call depth of the identified function is already registered in the profile information DB 300, the analysis unit 403 counts up the count corresponding to the pair by one.

In the example of FIG. 5, the counts of pairs of the subroutine names and call depths “1: main”, “2: A”, “3: B”, “4: C”, and “5:B” are counted up by one, respectively.

Here, the stored contents of the profile information DB 300 when the execution of the program P is ended will be described with reference to FIG. 6.

FIG. 6 is a diagram illustrating an example of stored contents of the profile information DB 300. In FIG. 6, the profile information 600-1 to 600-6 is stored in the profile information DB 300. For example, the profile information 600-1 indicates a count “2813” of the subroutine having the subroutine name of “main” with the call depth “1”.

The count corresponding to the pair of the call depth and subroutine name indicates that processing time of the corresponding subroutine becomes longer as a value of the count is increased. As described above, a stack frame generated when a function (subroutine) is called remains in a stack area sa until the called function returns, that is, a process of the called function is ended. Accordingly, each time when a function is newly called, the count for each function with each call depth identified from each stack frame within the stack area sa is counted up so as to make it possible to obtain information indicating the length of the processing time of the function.

Referring back to the description with reference to FIG. 4, the reception unit 401 receives a designation of a first function within the program P. The first function is, for example, a function arbitrarily designated by a developer M (FIG. 1) of the program P. Specifically, for example, the reception unit 401 may receive an execution state display command through an input operation performed by the user using the input device 207. The reception unit 401 may receive the execution state display command from another device through the network 210.

The execution state display command corresponds to a display request for displaying an execution state of the program P. The execution state display command includes, for example, a program name of a program P to be analyzed, information (file name) for identifying profile information to be referenced, and a function name (subroutine name) of the first function.

The extraction unit 404 references the generated profile information and extracts another function with the same call depth as that of the designated first function. Specifically, for example, the extraction unit 404 references the profile information DB 300 illustrated in FIG. 6 and extracts another subroutine with the same call depth as that of the designated first function.

As an example, it is assumed that the subroutine name “D” is designated as the function name of the first function. In this case, the extraction unit 404 references the profile information DB 300 (FIG. 6) and extracts a subroutine C( ) with the same call depth of “4” as that of a designated subroutine D( ).

In the program P, a recursive call may be made in which a function calls itself to perform its process repeatedly. In this case, a function called at a point with the shallowest call depth may be regarded as the most important function, that is, a function indicating a processing phase. For example, when the factorial “n!” is recursively calculated using a fact( ) function, a time from the call of fact(n) to the completion of fact(n) through calculations of fact(n−1), fact(n−2), . . . , is the processing time taken for fact(n).

Accordingly, when the first function is a function called with a plurality of different depths, the extraction unit 404 may extract a function with the same call depth as the minimum call depth of the first function. As an example, it is assumed that a subroutine name “B” is designated as a function name of the first function. The subroutine B( ) is called at the call depths of “3” and “5” (FIG. 6).

In this case, the extraction unit 404 references the profile information DB 300 (FIG. 6) and extracts a subroutine with the same call depth as the call depth of “3” which is the minimum call depth of the designated subroutine B( ). However, in the example of FIG. 6, another subroutine with the call depth of “3” does not exist and thus, no function is extracted.

The calculation unit 405 calculates a proportion of a value indicating a length of processing time of respective functions (including the first function) on the basis of the value indicating the length of processing time of the respective functions with the same call depth as that of the first function. The proportion of the value indicating the length of processing time of the respective functions with the same call depth serves as an index for determining the proportions of processing phases of the respective functions executed within the program P.

As an example, it is assumed that a subroutine name of “D” is designated as a function name of the first function and a subroutine C( ) with the same call depth of “4” is extracted. In this case, the calculation unit 405 references, for example, the profile information DB 300 (FIG. 6) and identifies a count “2300” of the subroutine C( ) with the call depth of “4” and a count “500” of the subroutine D( ).

Next, the calculation unit 405 calculates a value T of “2800” which is a total of the counts of the identified subroutines C( ) and D( ). Then, the calculation unit 405 divides “2300” and “500”, which are the counts of the subroutines C( ) and D( ), respectively, by total value T “2800”, so as to obtain “0.821” and “0.179” which indicate the proportions of the lengths of processing time of the subroutines C( ) and D( ), respectively. In this case, the calculation unit 405, for example, may multiply each proportion by “100” to obtain an execution proportion of the respective subroutines C( ) and D( ) (unit: %).

The output unit 406 outputs information of the extracted other function. The information of the extracted other function is information capable of identifying a function with the same call depth as that of the first function. An outputting form of the output unit 406 includes, for example, displaying of information on the display 206, transmitting of information to an external device by the I/F 205, storing of information in a storage device such as the memory 202 or the disk 204, print-out of information to a printer, which is not illustrated, and the like.

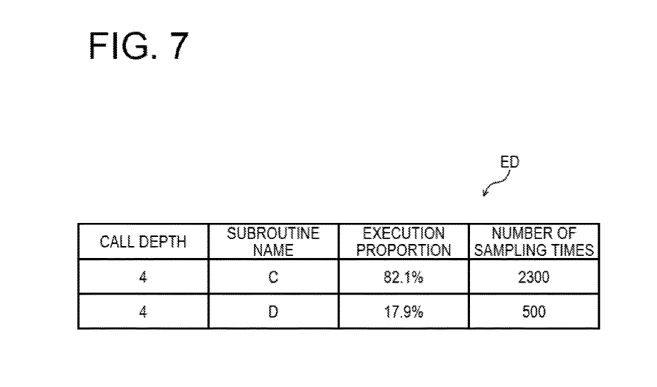

Specifically, the output unit 406 may reference, for example, the profile information DB 300 and output execution state information ED (FIG. 7) indicating function names of respective functions with the same call depth as that of the first function. The execution state information ED corresponds to, for example, the execution state information 120 illustrated in FIG. 1. With this, it becomes possible to grasp a function having a high possibility of being executed with the first function in a pair.

The output unit 406 may reference, for example, the profile information DB 300 and output the execution state information ED including the values indicating the lengths of processing time of respective functions with the same call depth as that of the first function. With this, it becomes possible to determine the proportions of processing phases executed by the respective functions within the program P.

Furthermore, the output unit 406 may reference, for example, the profile information DB 300 and output the execution state information ED including the proportions (execution proportions) of the values indicating the lengths of processing time of the respective functions with the same call depth as that of the first function. With this, it becomes possible to more intuitively determine the proportions of processing phases executed by the respective functions within the program P.

A specific example of execution state information ED will be described later with reference to FIG. 7.

When another function with the same call depth as that of the first function is not extracted, the output unit 406 may output, for example, information indicating that another function with the same call depth as that of the first function does not exist. With this, it is possible to grasp the fact that another function having a high possibility of being executed with the first function in a pair does not exist.

Next, the specific example of the execution state information ED will be described with reference to FIG. 7. Here, a case will be described as an example where the subroutine D( ) is designated as the first function and as a result, the subroutine C( ) with the same call depth “4” is extracted.

FIG. 7 is a diagram illustrating a specific example of the execution state information ED. In FIG. 7, the execution state information ED is information indicating a call depth, a subroutine name, an execution proportion, the number of sampling times in association with each other. The execution state information ED is displayed on, for example, the display 206.

The call depth is a call depth of a function (subroutine) within the program P and corresponds to the call depth of the designated first function. The subroutine name corresponds to a function name of the respective functions. The execution proportion indicates an execution proportion based on the proportion of the value indicating the length of processing time of the respective functions.

By referencing the execution state information ED, for example, the developer M may grasp the subroutine C( ) having a high possibility of being executed with the designated subroutine D( ) in a pair. The developer M may determine the proportions of processing phases executed within the program P by the respective subroutines C( ) and D( ).

In the example of FIG. 7, the execution proportion “82.1%” of the subroutine C( ) greatly exceeds the execution proportion “17.9%” of the subroutine D( ). Therefore, the developer M may understand that a processing phase for which the subroutine C( ) is responsible is more dominant than other processing phases within the program P and the relevant processing phase has a high possibility of being the bottleneck.

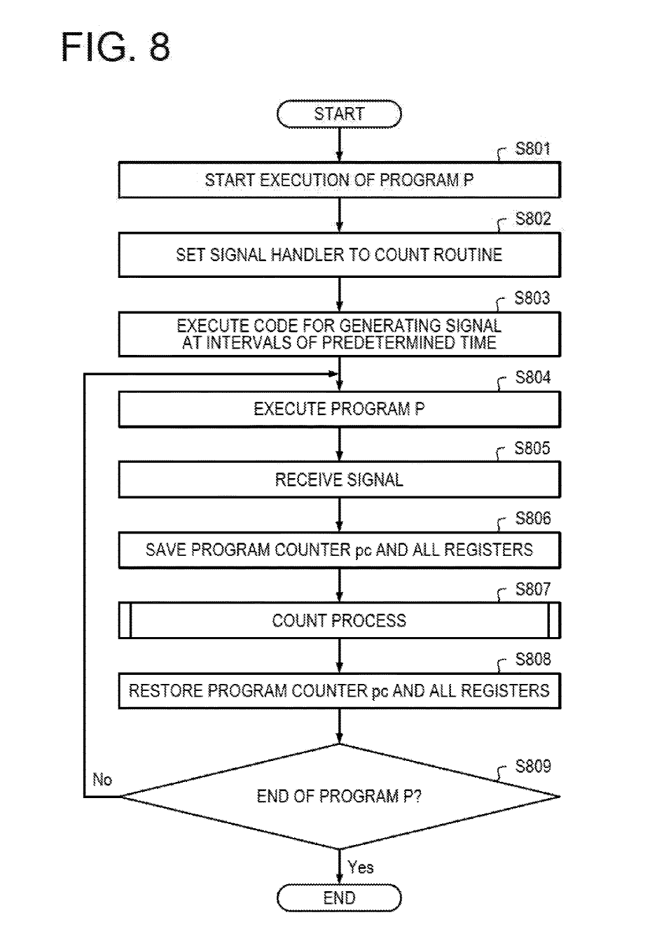

Next, various processing performed by the information processing device 100 will be described. First, processing of generating profile information performed by the information processing device 100 will be described with reference to FIG. 8.

FIG. 8 is a flowchart illustrating exemplary processing of generating profile information performed by the information processing device 100. First, the information processing device 100 starts execution of the program P (S801). Next, the information processing device 100 sets a signal handler to a COUNT routine (S802) and executes a code for generating a signal at intervals of a predetermined time (S803).

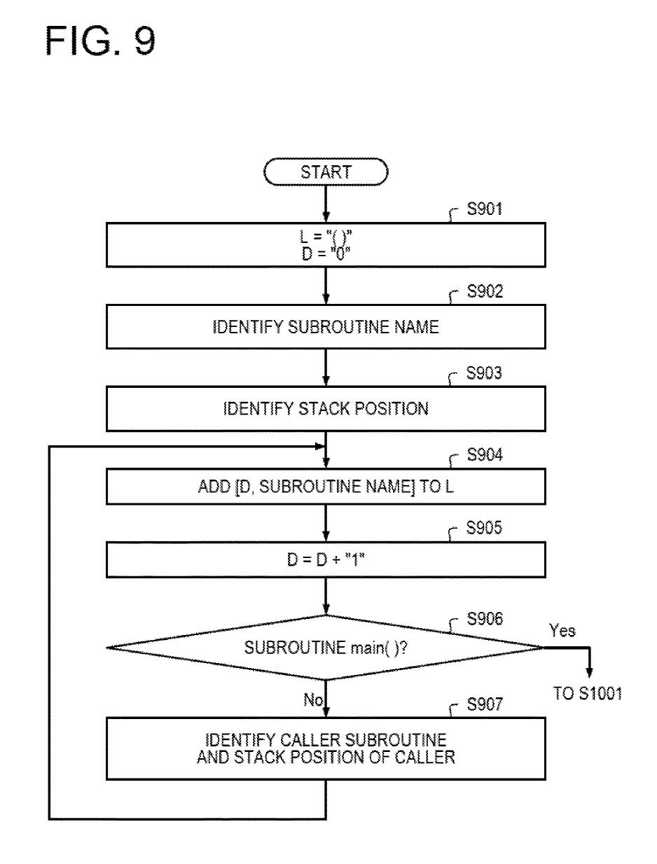

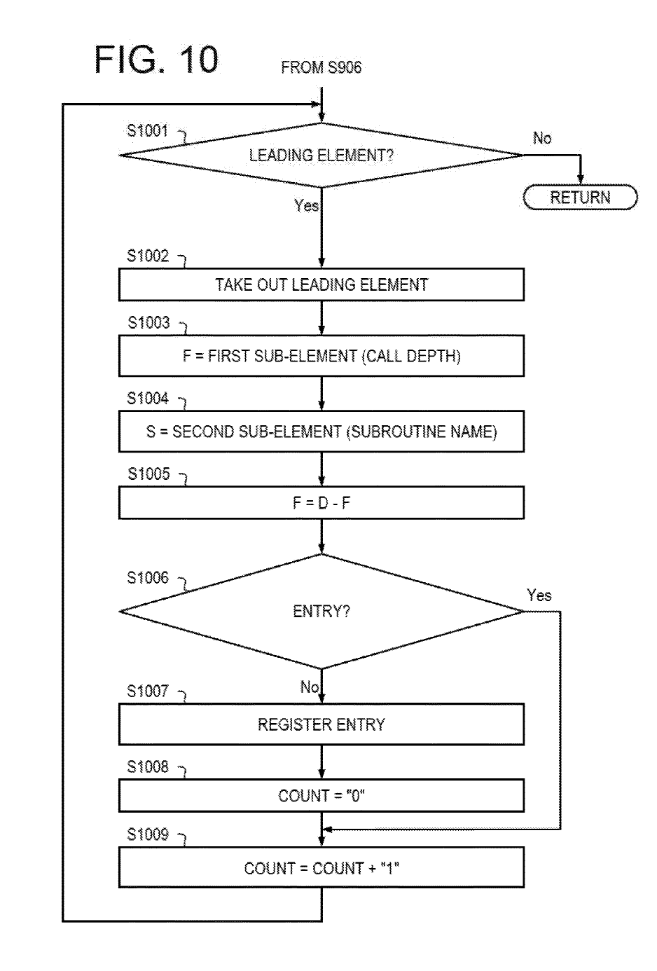

The information processing device 100 resumes the execution of the program P if the execution of the program P has been suspended (S804). When the signal is received (S805), the information processing device 100 suspends the execution of the program P and saves the values of the program counter pc and all the registers (S806). The information processing device 100 executes a COUNT process (S807). Specific processing in the COUNT process will be described later with reference to FIG. 9 and FIG. 10.

Next, the information processing device 100 restores the program counter pc and all the registers (S808) and determines whether execution of the program P is ended (S809). When it is determined that the execution of the program P is not ended (S809: No), the information processing device 100 returns to S804.

When it is determined that the execution of the program P is ended (S809: Yes), the information processing device 100 ends the processing in the flowchart. With this, it is possible to generate or update the profile information indicating an execution state of the program P each time the signal generated at intervals of a predetermined time is received.

Next, the specific processing of the COUNT process in S807 illustrated in FIG. 8 will be described with reference to FIG. 9 and FIG. 10.

FIG. 9 and FIG. 10 are flowcharts illustrating exemplary processing in the COUNT process. First, the information processing device 100 sets “( )” (empty list) to L and “0” to D (S901) and identifies a subroutine name of the current subroutine from the value of the program counter pc (S902).

The information processing device 100 identifies the current stack position from the value of the stack pointer sp (S903). The information processing device 100 adds a “[D, subroutine name]” to L (S904). The information processing device 100 increments D by “1” (one) (S905) and determines whether a subroutine having the subroutine name added to L is main( ) (S906).

When it is determined that the subroutine is not main( ) (S906: No), the information processing device 100 identifies a subroutine serving as a caller and a stack position of the caller from the current stack position (S907), and returns to S904. In S907, when the stack position of the caller is identified, the identified stack position becomes the current stack position.

When it is determined that the subroutine is main( ) (S906: Yes), the information processing device 100 proceeds to S1001 in FIG. 10.

The information processing device 100 determines whether a leading element of L is present (S1001). When it is determined that the leading element is present (S1001: Yes), the information processing device 100 takes off the leading element of L (S1002).

Next, the information processing device 100 sets a first sub-element of the taken-off leading element to F (call depth) (S1003) and sets a second sub-element of the taken-off leading element to S (subroutine name) (S1004). The information processing device 100 subtracts F from D and sets the result to F (S1005).

Next, the information processing device 100 determines whether an entry for F and S is present in the profile information DB 300 (S1006). When it is determined that an entry for F and S is present (S1006: Yes), the information processing device 100 proceeds to S1009.

When it is determined that no entry for F and S is present (S1006: No), the information processing device 100 registers an entry for F and S in the profile information DB 300 (S1007) and sets “0” to the count in the entry (S1008). Also, the information processing device 100 increments the count in the entry for F and S by “1” (one) (S1009) and returns to S1001.

When it is determined that the leading element of L is absent (S1001: No), the information processing device 100 returns to a point at which the COUNT process is called. With this, it is possible to generate or update profile information indicating a subroutine name, a call depth, and a count (value indicating a length of processing time) of a subroutine called during execution of the program P.

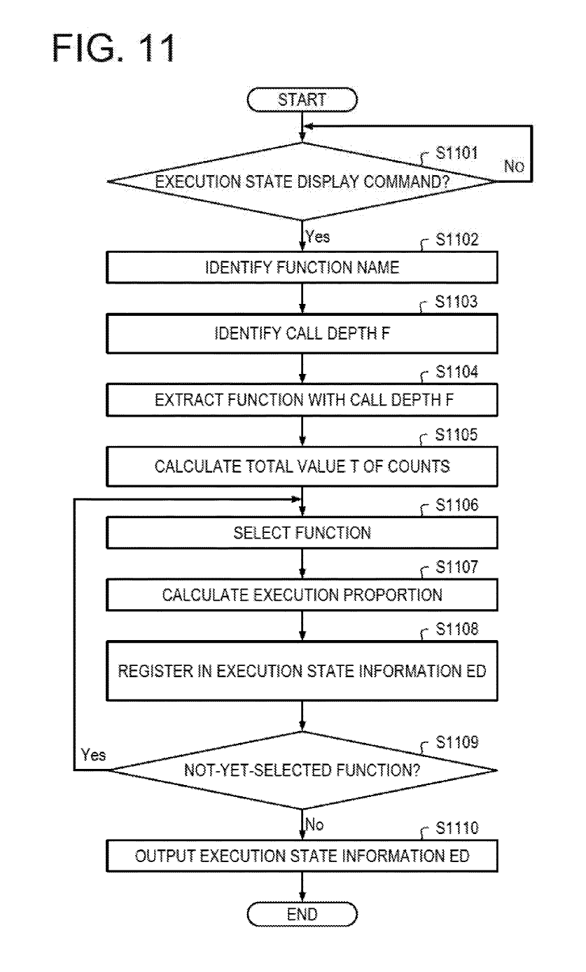

Next, processing of displaying a program execution state performed by the information processing device 100 will be described with reference to FIG. 11.

FIG. 11 is a flowchart illustrating exemplary processing of displaying a program execution state. First, the information processing device 100 determines whether an execution state display command is received (S1101). The information processing device 100 waits for reception of an execution state display command (S1101: No).

When it is determined that an execution state display command is received (S1101: Yes), the information processing device 100 references the execution state display command and identifies a function name (subroutine name) of the first function (S1102). The information processing device 100 references the profile information DB 300 and identifies a minimum call depth F corresponding to the identified function name (S1103).

The information processing device 100 references the profile information DB 300 and extracts functions with the identified call depth F (S1104). The information processing device 100 references the profile information DB 300 and calculates a total value T of the counts indicating the lengths of processing time of the extracted functions with the call depth F (S1105).

The information processing device 100 selects a function (not-yet-selected function) which is not yet selected among the extracted functions with the call depth F (S1106). Next, the information processing device 100 divides the count indicating the length of processing time of the selected function by the total value T to calculate an execution proportion of the selected function (S1107).

The information processing device 100 registers the call depth F, the function name, the execution proportion and the count of the selected function in the execution state information ED (S1108). The information processing device 100 determines whether a not-yet-selected function is present in the extracted functions with the call depth F (S1109).

When it is determined that a not-yet-selected function is present (S1109: Yes), the information processing device 100 returns to S1106. When it is determined that no not-yet-selected function is present (S1109: No), the information processing device 100 outputs the execution state information ED (S1110) and ends the processing in the flowchart.

With this, it is possible to output the execution state information ED indicating execution states of respective functions with the same call depth as that of the first function designated by, for example, a developer M.

As described above, in the information processing device 100 according to the embodiment, the designation of the first function within the program P is received and accordingly, it is possible to reference the profile information DB 300, extract another function with the same call depth as that of the designated first function, and output execution state information ED including information (e.g., a function name) of the extracted other function.

With this, it is possible to provide information of another function having a high possibility of being executed with the first function in a pair. Accordingly, for example, the developer M may grasp not only a processing phase handled by the first function but also another processing phase handled by another function within the program P.

According to the information processing device 100, when the first function is a function called at a plurality of different depths, it is possible to extract another function with the same call depth as the minimum call depth of the first function. With this, even when a function which is recursively called is designated, it is possible to extract a function having the high possibility of being executed with the first function in a pair by focusing on the function called at the shallowest depth which may be regarded as the most important function in representing the processing phase

According to the information processing device 100, it is possible to identify, at a predetermined timing during execution of the program P, call depths of the respective functions traced back along a sequence of function calls from the current function identified by information of the program counter pc to the function serving as the execution starting point, based on information of the stack area sa. With this, it is possible to identify the call depths of respective functions within the program P using a data structure (LIFO) of the stack area sa.

According to the information processing device 100, it is possible to count up the value indicating the length of processing time of the function corresponding to the call depth in response to identification of the call depth of the function at the predetermined timing during execution of the program P. With this, it is possible to calculate the value indicating the length of processing time of each function within the program P.

According to the information processing device 100, it is possible to output a value indicating the length of processing time of the first function and a value indicating the length of processing time of another function at the same call depth. With this, it becomes possible to determine the proportions of processing phases executed by respective functions within the program P.

According to the information processing device 100, it is possible to calculate the proportion of the value indicating the length of processing time of each function on the basis of the values indicating the lengths of processing time of respective functions with the same call depth and output the calculated proportion of the value indicating the length of processing time of each function. With this, it becomes possible for the developer M to more intuitively determine the proportions of processing phases executed by respective functions within the program P.

Therefore, according to the information processing device 100, it is possible to readily perform an analysis of detailed breakdowns of an execution time of a processing phase composed of several processes without modifying an object code. With this, it becomes possible for a user who is unfamiliar with inside of the program P to determine a bottleneck point.

The information processing device described in the embodiment may be implemented by causing a computer such as a personal computer or a workstation to execute a program prepared in advance. A program for displaying a program execution state is recorded in a computer-readable recording medium such as a hard disk, a flexible disk, compact disc ROM (CD-ROM), a magneto-optical (MO) disk, a digital versatile disk (DVD), and a universal serial bus (USB) memory, and read out from the recording medium by the computer, thereby being executed. The program for displaying a program execution state may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device, comprising:
a memory; and
a processor coupled to the memory and the processor configured to:
receive a designation of a first function within a first program;
extract, from among third functions called in first function calls during execution of the first program, a second function with a call depth same as a call depth of the first function on basis of execution information, the call depth of a specific function being a number of functions traced along a sequence of second function calls from a start function to the specific function, the execution information indicating call depths of the respective third functions, the start function being a function with which the execution of the first program starts; and
output information of the second function.

2. The information processing device according to claim 1, wherein the processor is configured to:
extract, as the second function, a function with a call depth same as a minimum call depth of the first function when the execution information indicates different depths of the first function.

3. The information processing device according to claim 1, wherein the processor is configured to:
identify on basis of information stored in a stack area, at a predetermined timing during the execution of the first program, respective call depths of fourth functions traced back along a sequence of third function calls from a current function to the start function, the current function being identified by information indicated by a program counter indicating a currently executed point, the stack area storing therein information of callers of the first function calls; and
generate the execution information on basis of the identified call depths.

4. The information processing device according to claim 3, wherein the processor is configured to:
count up first values indicating lengths of processing time of the respective fourth functions;
generate the execution information including the first values at a time when the execution of the first program is ended; and
output, on basis of the execution information, a value indicating a length of processing time of the first function and a value indicating a length of processing time of the second function.

5. The information processing device according to claim 4, wherein the processor is configured to:
calculate, on basis of second values indicating lengths of processing time of respective functions with a call depth same as the call depth of the first function, respective proportions of the second values, the second values being included in the execution information; and
output the calculated proportions.

6. The information processing device according to claim 3, wherein
the predetermined timing is a timing at a predetermined time interval or a timing at which any one of the third functions is called.

7. A method of displaying a program execution state, the method comprising:
receiving, by a computer, a designation of a first function within a first program;
extracting, from among third functions called in first function calls during execution of the first program, a second function with a call depth same as a call depth of the first function on basis of execution information, the call depth of a specific function being a number of functions traced along a sequence of second function calls from a start function to the specific function, the execution information indicating call depths of the respective third functions, the start function being a function with which the execution of the first program starts; and
outputting information of the second function.

8. A non-transitory computer-readable recording medium having stored therein a program that causes a computer to execute a process, the process comprising:
receiving a designation of a first function within a first program;
extracting, from among third functions called in first function calls during execution of the first program, a second function with a call depth same as a call depth of the first function on basis of execution information, the call depth of a specific function being a number of functions traced along a sequence of second function calls from a start function to the specific function, the execution information indicating call depths of the respective third functions, the start function being a function with which the execution of the first program starts; and
outputting information of the second function.
